(19) United States
(12) Patent Application Publication
(10) Pub. No.: US 2014/0060885 A1
(43) Pub. Date: Mar. 6, 2014

(54) CABLE STRUCTURES AND SYSTEMS AND METHODS FOR MAKING THE SAME

(71) Applicants: John B. Ardisana, II, San Francisco, CA (US); Edward Siahaan, San Francisco, CA (US)

(72) Inventors: John B. Ardisana, II, San Francisco, CA (US); Edward Siahaan, San Francisco, CA (US)

(73) Assignee: APPLE INC., Cupertino, CA (US)

(21) Appl. No.: 13/599,634

(22) Filed: Aug. 30, 2012

(51) Int. Cl. H01B 7/18; B29C 70/22

(52) U.S. Cl. 174/102 C; 28/169

(57) ABSTRACT

Cable structures can be formed for cables and other components that include non-cable components such as jacks and headphones. The cable structure includes an inner wrap that is formed from a metallic doped fabric that can be spiral wound around a conductive bundle such that it essentially completely encapsulates the conductive bundle. The inner surface of fabric, which is on contact with the conductive bundle, is treated such that it acts as an insulator. The exterior surface of the fabric is essentially conductive. A metal braid can then be applied over the exterior surface of the fabric, such that the metal braid and fabric are electrically coupled together to enhance EMI shielding in the cable.

### BACKGROUND

The ever increasing use of portable electronic devices, such as portable music players and mobile phones, has led to wide spread use of data cables that users utilize for a variety of purposes. A large majority of those cables are manufactured using common techniques. For example, many of those cables utilize thermoplastic (TPE) or thermoplastic polyurethane (TPU) elastomers for the cable jacket material. Many of those cables are manufactured by wrapping the conductive bundle in a foil shield prior to the addition of a metal braid that is used for shielding (and then, the jacket material is often extruded to cover the entire sub-assembly).

The foil shield is often based on a film of polyethylene terephthalate (PET) that has a metal such as aluminum evaporated on one side of it. The PET side of the film provides an insulator that protects the conductive bundle, while the metal coated side is in constant contact with the metal braid to further enhance the shielding properties of the cable.

These cables provide a given level of performance with regard to shielding, abrasive wearing, bending, etc. Over time, however, the given level of performance often cannot be sustained. As the cable is bent through ordinary use, the evaporated metal can tend to begin flaking off the film. This can be caused, for example, by simple bending of the cable that results in the film rubbing against the metal braid. This can lead to a number of potential problems that reduces the reliability of the cable, and could ultimately cause the cable to fail. For example, the loose metal particles can begin causing the cable itself to break down and/or reduce the effectiveness of the shielding effects (electro-magnetic interference (EMI) and/or electro-magnetic compliance (EMC)). In a worst case situation, if enough metal flakes off the film, the build up of flaked metal could potentially cause a short between one or more of the conductors, leading to a total failure of the cable.

The one or more cables can be manufactured using different approaches.

### SUMMARY

Cable structures and systems and methods for manufacturing cable structures are disclosed.

A cable structure can be utilized in many ways. In some instances, the cable structure can be as simple as a cable with a connector at each end. In other instances, such as a headset, the cable structure can be used to interconnect various non-cable components such as, for example, a plug, headphones, and/or a communications box to provide the completed headset. In some instances, the cable structure can include several legs (e.g., a main leg, a left leg, and a right leg) that each connect to a non-cable structure, and each leg may be connected to one another at a bifurcation region (e.g., a region where the main leg appears to split into the left and right legs). Cable structures according to embodiments of this invention provide aesthetically pleasing cables that provide a constant, high level of performance over a longer period of time, regardless of how they are handled by the user.

The cable structures described herein in accordance with the principles of the present invention utilize metallic doped fabrics in place of traditional foil shield materials (e.g., the aluminum coated PET film). The metallic doped fabrics tend to hold on to the metallic material in a more reliable manner over a longer period of time, at least in part, because fabric is more flexible than PET films. Therefore, the cables should tend to maintain their high level of performance over a longer time. As the cable is bent and flexed by the user, the doped fabric will retain significantly more of the metallic material, and the EMI/EMC shielding capabilities should not be degraded.

It also may be beneficial to combine the doped fabric material with a PET carrier so that the manufacturing process for making the cables does not have to be altered. For example, the doped metallic fabric can be boded to PET carrier in a manner similar to the traditional aluminum coated PET film. The fabric/carrier combination can be provided to the cable manufacturer in the same traditional manner as the aluminum coated PET film. During cable manufacturing, the fabric/carrier material can be wrapped around the conductive bundle prior to the application of the metal braid without altering that portion of the cable manufacturing process. Accordingly, cables made in accordance with these principles should have a longer useful life in which the high level of performance is maintained.

### BRIEF DESCRIPTION OF THE DRAWINGS

The above and other aspects and advantages of the invention will become more apparent upon consideration of the following detailed description, taken in conjunction with accompanying drawings, in which like reference characters refer to like parts throughout, and in which:

FIG. 1 shows an illustrative cross-sectional view of a cable structure constructed in accordance with some embodiments of the invention;

FIG. 2 is a cross-sectional view of an illustrative extruder in accordance with some embodiments of the invention;

FIG. 3 is a flowchart of an illustrative process for forming a metallic doped fabric cable wrap structure in accordance with some embodiments of the invention; and

FIG. 4 is a flowchart of an illustrative process for extruding a cable structure in accordance with some embodiments of the invention.

### DETAILED DESCRIPTION OF THE DISCLOSURE

Cable structures for use with portable electronic devices are disclosed. The cable structures disclosed herein can be used for various purposes. For example, one could use these cables structures for data transfer cables that enable users to put content on, and extract content from, their portable electronic devices. In other instances, these cables structures may be used to manufacture headsets that can be used daily, regardless of the environmental conditions. For example, these cable structures can be used to interconnect various non-cable components to form a headset, such as, a plug, headphones, and/or a communications box to provide the headset. In many of these circumstances, users tend to desire cables that are aesthetically pleasing and are durable and long lasting. In general, users receive the cables they need when they purchase an electronic device. For example, when a user purchases a portable electronic device such as an iPhone™ by Apple Inc., the packaging also includes a data transfer cable and a headphone cable, both of which are expected to work until the device itself is replaced.

Each of these cables, however, are likely to be subjected to a bevy of bending and twisting during their normal life (such as, for example, when shoved into the user's pocket, purse or briefcase). That bending and twisting can cause traditional cables to breakdown, such that performance issues occur or total failure occurs. In instances where the cables are formed from a conductive bundle that is wrapped with a metal deposited PET carrier, the bending and twisting can cause the deposited material to flake off. At a minimum, the loss of material can cause a loss in the effectiveness of the EMI/EMC shielding.

The use of metallic doped fabric, unlike aluminum deposited on film, allows the cable wrap to be rubbed against the metal braid inside the cable (during bending and twisting) without causing a loss of metal from the fabric. This enables the cable to maintain acceptable EMI/EMC shielding performance for a longer period of time than traditional cables. Moreover, if the metallic doped fabric is bonded to a PET base, the subassembly can be prepared such that it can be spiral wound onto the cable during the manufacturing process in the same manner as the traditional aluminum doped PET carrier is used. This enables the manufacturing process to be improved without altering the process itself.

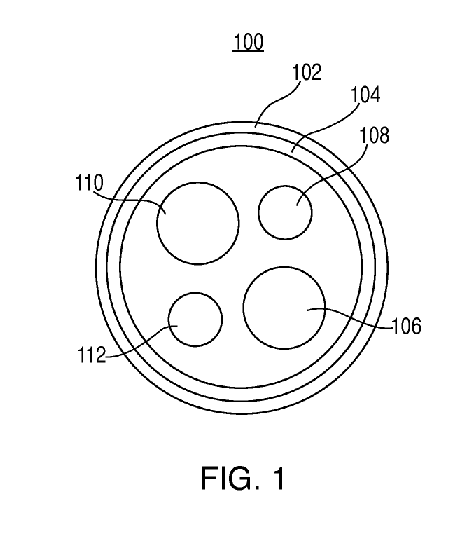

FIG. 1 shows an illustrative cross-sectional view of a cable structure in accordance with the principles of the present invention. Cable structure 100 includes outer jacket 102, EMI/EMC wrap 104, and conductors 106, 108, 110 and 112. In the illustration shown in FIG. 1, cable 100 could, for example, be utilized as a USB cable, which requires four conductors for normal operations. EMI/EMC wrap 104, in this instance, is formed from metallic doped fabric instead of the traditional aluminum deposited PET film. Moreover, the metallic doped fabric is created in such a manner that it can be a one-for-one replacement for the PET film in the cable manufacturing process without requiring retooling, such that the necessary manufacturing rates can be maintained.

The metallic coated fabric can be formed in a number of different manners. For example, dipping fabric in a nickel solution, which would alter the characteristics of the fabric such that it can carry a charge in sheet form, may form the metallic coated fabric. The fabric can then be bonded to PET film and processed such that it can be spiral wound on to the cable during the normal cable manufacturing process. That processing can include the material being cut into strips that can be 10-12 millimeters wide, and wound onto spools in preparation for the cable manufacturing process.

Accordingly, EMI/EMC wrap 104 is formed from a combination of materials including a metallic doped fabric. An alternative approach to bonding the fabric with a PET film is to apply a PET solution to one side of the fabric, such that the applied side acts as an insulator. In this manner, the pre-manufacturing process may be easier to perform since all of the steps utilize processes for coating the fabric. In either case, less than one millimeter would be added to the overall thickness of the material. The fabric-based EMI/EMC wrap can thereby be a complete, one-for-one replacement for the aluminum deposited PET film. In that regard, fabric-based EMI/EMC wraps tend to result in cables that will maintain their EMI/EMC performance even after they have been repeatedly bent and mangled. Wrap 104 is essentially a multi-functional component in the cable assembly because it acts both as a conductor (for the metal braid, at least to enhance shielding), and as an insulator (for the conductors, to at least enhance shielding).

Moreover, cables formed using fabric-based EMI/EMC wraps should have a significantly longer useful life than traditional cables. This can be accomplished without adding significantly to the overall diameter of the cable.

As described above, the cable structures of the present invention can be constructed following a traditional process. Once the fabric-based EMI/EMC wrap has been applied, and the metal braid installed, the cable jacket can be formed by extrusion. The extrusion process used can be selected such that varying types of cables can be formed. For example, extrusion can be used to form simple two-ended cables, or more complex cables having multiple ends feeding off of one or more joints. Under such circumstances, each of the individual regions, such as a taper region, a non-interface region, and a bifurcation region of each leg can be constructed seamlessly as part of the extrusion process. Moreover, each region of the leg can have a different diameter (e.g., a different cross-section), based on the particular extrusion process selected.

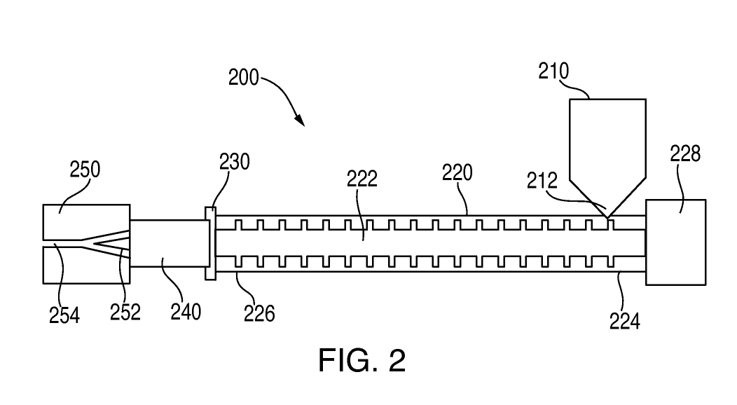

FIG. 2 is a cross-sectional view of an illustrative extruder in accordance with some embodiments of the invention. Extruder 200 can receive a material to extrude in a first form, such as pellets, and can transform the material to a form corresponding to cable structure 100. The extrusion process can be performed in the same manner with fabric based EMI/EMC wraps, as was performed with aluminum deposited PET films, a least because the extruded material does not adversely affect the metallic doped fabric.

Extruder 200 can extrude any suitable material to create cable structure 100. Material can be provided to extruder 200 in any suitable form including, for example, in liquid or solid form. In one implementation, pellets or chips of material can be provided to hopper 210 for processing. The material can pass through feedthroat 212 and enter barrel 220. Screw 222 can rotate within barrel 220 to direct material from hopper end 224 of the barrel to die end 226 of the barrel. Drive motor 228 can be mechanically connected to screw 222 such that the screw can rotate to direct material received from hopper 210 towards die end 226. The drive motor can drive screw 222 at any suitable rate or speed, including a variable speed based on a manner in which the process is executed.

Barrel 220 can be heated to a desired melt temperature to melt the material provided in hopper 210. For example, barrel 220 can be heated to a temperature in the range of 200° C. to 300° C. (e.g., 250° C.), although the particular temperature can be selected based on the material used. As the material passes through barrel 220, pressure and friction created by screw 222, and heat applied to barrel 220 by a heating component can cause the material to melt and flow. The resulting material can be substantially liquid in a region near die end 226 of barrel 220 so that it may easily flow into die 250. In some cases, different amounts of heat can be applied to different sections of the barrel to create a variable heat profile. In one implementation, the amount of heat provided to barrel 220 can increase from hopper end 224 to die end 226. By gradually increasing the temperature of the barrel, the material deposited in barrel 220 can gradually heat up and melt as it is pushed toward die end 226. This may reduce the risk of overheating, which may cause the material to degrade. In some embodiments, extruder 200 can include cooling components (e.g., a fan) in addition to heating components for controlling a temperature profile of barrel 220.

In some cases, one or more additives can be added to the material within barrel 220 to provide mechanical or finishing attributes to cable structure 100. For example, components for providing flame retardation, modifying a coefficient of friction of an outer surface of cable structure 100, refining a color of cable structure 100, or combinations of these can be used. The additives can be provided in hopper 220, or alternatively can be inserted in barrel 220 at another position along the barrel length. The amount of additives added, and the particular position at which additives are added can be selected based on attributes of the material within the barrel. For example, additives can be added when the material reaches a particular fluidity to ensure that the additives can mix with the material.

Screw 222 can have any suitable channel depth and screw angle for directing material towards die 250. In some cases, screw 222 can define several zones each designed to have different effects on the material in barrel 220. For example, screw 222 can include a feed zone adjacent to the hopper and operative to carry solid material pellets to an adjacent melting zone where the solid material melts. The channel depth can progressively increase in the melting zone. Following the melting zone, a metering zone can be used to melt the last particles of material and mix the material to a uniform temperature and composition. Some screws can then include a decompression zone in which the channel depth increases to relieve pressure within the screw and allow trapped gases (e.g., moisture or air) to be drawn out by vacuum. The screw can then include a second metering zone having a lower channel depth to re-pressurize the fluid material and direct it through the die at a constant and predictable rate.

When fluid material reaches die end 226 of barrel 220, the material can be expelled from barrel 220 and can pass through screen 230 having openings sized to allow the material to flow, but preventing contaminants from passing through the screen. The screen can be reinforced by a breaker plate used to resist the pressure of material pushed towards the die by screw 222. In some cases, screen 230, combined with the breaker plate, can serve to provide back pressure to barrel 220 so that the material can melt and mix uniformly within the barrel. The amount of pressure provided can be adjusted by changing the number of screens used, the relative positions of the screens (e.g., mis-aligning openings in stacked screens), or changing the size of openings in a screen.

The material passing through the screen is directed by feedpipe 240 towards die 250. Feedpipe 240 can define an elongated volume through which material can flow. Unlike in barrel 220, in which material rotates through the barrel, material passing through feedpipe 240 can travel along the axis of the feedpipe with little or no rotation. This can ensure that when the material reaches the die, there are no built-in rotational stresses or strains that can adversely affect the resulting cable structure (e.g., stresses that can cause warping upon cooling).

Fluid material passing through feedpipe 240 can reach die 250, where the material is given a profile corresponding to the final conductor structure. Material can pass around pin 252 and through opening 254 of the die. Pin 252 and opening 254 can have any suitable shape including, for example, circular shapes, curved shapes, polygonal shapes, or arbitrary shapes. In some embodiments, pin 252 can be movable within die 250. In some embodiments, elements of die 250 can move such that the size or shape of opening 254 can vary. Once material has passed through the die, the material can be cooled to maintain the extruded shape. The material can be cooled using different approaches including, for example, liquid baths (e.g., a water bath), air cooling, vacuum cooling, or combinations of these.

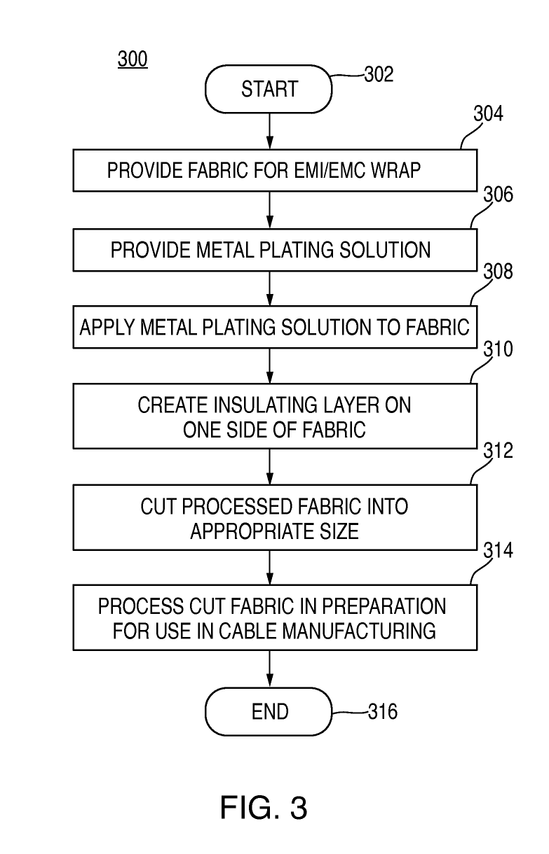

FIG. 3 is a flowchart of an illustrative process 300 for pre-manufacturing EMI/EMC wrap material that can be utilized in the production of cables that are traditionally used with portable electronic devices. Process 300 can begin at step 302. At step 304, fabric is provided that will be processed into EMI/EMC wrap material. At step 306, the metal plating solution can be provided. The metal plating solution can be any solution that can be used in an electro-less depositing process. For example, one common metal solution used in such processes is nickel. Nickel is a relatively inexpensive metal that can be abundantly located, and which coats fabric such that the fabric can subsequently carry a charge in sheet form. Moreover, the use of nickel plating can be accomplished at substantially the same dimensions as the fabric exists without the plating (e.g., dipping fabric in nickel plating solution should result in an increased in thickness of less than 0.05 millimeters).

At step 308, the metallic plating solution is applied to the fabric. The process step can be accomplished in varying manners. For example, the fabric can be dipped into the metallic plating solution, such that both sides of the fabric are coated. Alternately, the metallic plating solution can be sprayed onto the fabric on one or both sides. In order for step 308 to be accomplished, only one side of the fabric need be coated. At step 310, one side of the fabric is formed into an insulator. Like step 308, step 310 can be accomplished in a variety of different ways. In one instance, the coated fabric can be bonded to a PET film such that one side of the fabric is conductive and the other side is not. Alternately, PET material can be spray coated onto one side of the doped fabric, such that the sprayed side now acts as an insulator instead of as a conductor.

At step 312, the processed doped fabric is cut into the appropriate size for use in the cable manufacturing process. This process step may, for example, cut the doped fabric into strips that can be on the order of 10-12 millimeters wide. At step 314, the cut strips are further processed onto spools or other appropriate equipment such that the doped fabric can be spiral wound onto the conductor bundle of the cable during normal cable manufacturing. Process 300 can end at step 316.

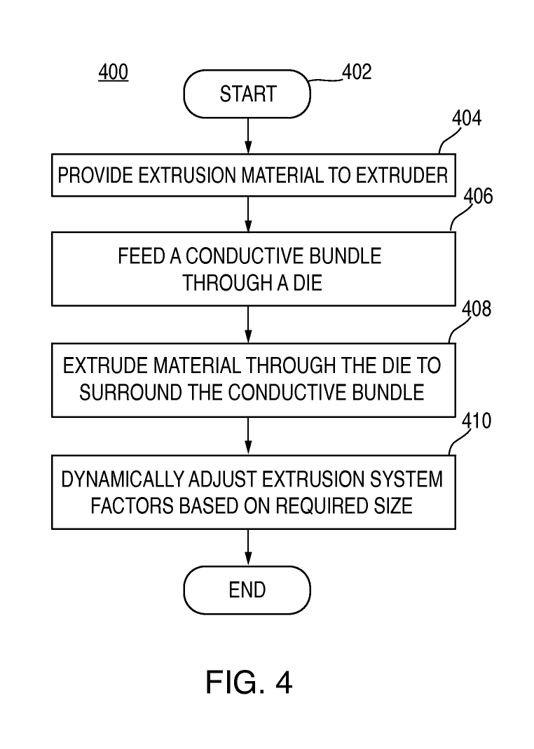

FIG. 4 is a flowchart of an illustrative process 400 for extruding a leg of a cable structure. Process 400 can begin at step 402. At step 404, material to be extruded can be provided to an extruder. For example, material pellets can be placed in a hopper of an extruder. The extruder can melt the material, and apply pressure to the melted material so that it may be directed out of the extruder. At step 406, a conductor bundle that has been wrapped with fabric-based EMI/EMC wrap can be fed through a die. For example, a bundle that includes conductors and a nickel doped EMI/EMC fabric wrap can be placed within a hypodermal path. Or, for example, a series of four conductors such as those shown in FIG. 1 can be fed through the die.

At step 408, the material can be extruded through the die to surround the conductor bundle, which is also passing through the die. The combination of the extruded material and conductor bundle form an extruded leg. At step 410, system factors of the extruder can be dynamically adjusted to change dimensions of the extruded cable as required to meet performance needs. In particular, the diameter of any extruded cable component can change from a large diameter in an interface region to a variable diameter defining a smooth transition from the large diameter to a small diameter of a non-interface region. Any suitable system factor can be changed including, for example, the position of die components (e.g., the position of the die pin), line speed, heat applied to the extruder, screw rotation speed, melt pressure, and air pressure, or combinations of these. Process 400 can end at step 412.

Manufacturing of cable structures having fabric-based EMI/EMC wraps can provide several advantages. For example, cable manufacturing process, including the extrusion process, can be performed using the fabric wrap as a one-for-one replacement for the aluminum deposited PET film traditional used. The metallic doped fabric-based materials results in cables that remain capable of providing EMI/EMC shielding that generally meets the same testing standards as when the cables were initially manufactured, for a longer period of time than traditionally manufactured cables. Moreover, the use of fabric-based EMI/EMC wraps can be accomplished without adversely affecting the overall cable dimensions. This, thereby, increases the durability and useful life of the cables.

The described embodiments of the invention are presented for the purpose of illustration and not of limitation.

What is claimed is:

1. A cable comprising:
a plurality of conductors;
a wrap comprising fabric having a first side and a second side, the first side comprising insulating material and the second side comprising conductive material, the first side being wrapped around, and in contact with, the plurality of conductors;
a metal braid that overlays the second side of the wrap; and
a cable jacket formed over the metal braid.

2. The cable of claim 1, wherein the first side of the wrap comprises:
a PET carrier bonded to the first side.

3. The cable of claim 1, wherein the first side of the wrap comprises:
a deposition of PET material that covers a substantial portion of the first side.

4. The cable of claim 1, wherein the wrap comprises:
fabric that was dipped in a metal plating solution.

5. The cable of claim 1, wherein the first side is non-conductive and the second side comprises:
a layer of sprayed conductive material.

6. The cable of claim 5, wherein the first side comprises:
a layer of sprayed PET.

7. Multi-function component for use in cable manufacturing comprising:
a spool less than one inch wide; and
fabric comprising a first side doped with a metallic material, and a second side that comprises insulating material, wherein the fabric is placed on the spool.

8. The component of claim 7, wherein the insulating material comprises:
a PET carrier bonded to the second side.

9. The component of claim 7, wherein the fabric comprises:
a textile; and
metallic plating solution applied to substantially all of the textile by dipping the textile into the metallic plating solution.

10. The component of claim 9, wherein the fabric further comprises:
a PET carrier bonded to one side of the textile.

11. A method for constructing EMI shielding material for use in electrical cables, the method comprising:
providing fabric;
providing metal plating solution;
applying the metal plating solution to at least one side of the fabric; and
creating an insulating layer on the other side of the fabric.

12. The method of claim 11, further comprising:
cutting fabric into a predetermined size after the step of creating an insulating layer; and
packaging the cut fabric for use in a cable manufacturing process.

13. The method of claim 11, wherein applying comprises:
dipping the fabric in the metallic plating solution.

14. The method of claim 11, wherein applying comprises:
spraying the metallic plating solution onto at least one side of the fabric.

15. The method of claim 11, wherein creating comprises:
bonding PET carrier to one side of the fabric.

16. The method of claim 11, wherein creating comprises:
spraying PET onto one side of the fabric.

17. The method of claim 11, wherein cutting comprises:
cutting the fabric into strips having a width of less than one inch.

18. The method of claim 17, wherein packaging comprises:
processing the cut fabric onto spool such that the fabric can be spiral wound on top of a bundle of conductors during an electrical cable manufacturing process.
